(19) United States
(12) Patent Application Publication
(10) Pub. No.: US 2016/0174649 A1
(43) Pub. Date: Jun. 23, 2016

(54) LIGHT EMITTING FOOTWEAR

(71) Applicant: Kenneth E. Bare, Deland, FL (US)

(72) Inventor: Kenneth E. Bare, Deland, FL (US)

(21) Appl. No.: 14/966,681

(22) Filed: Dec. 11, 2015

Related U.S. Application Data
(60) Provisional application No. 62/093,758, filed on Dec. 18, 2014.

(51) Int. Cl. A43B 3/00; F21V 23/04; F21S 9/02; F21V 23/06

(52) U.S. Cl. CPC A43B 3/001; F21V 23/06; F21V 23/0485; F21S 9/02; F21Y 2103/003

(57) ABSTRACT

Light emitting footwear includes an upper housing, a sole and a lighting unit. The sole is positioned beneath the upper housing and includes a translucent midsole and an outsole having a tread pattern along the bottom end thereof. The lighting unit is disposed within the midsole and functions to light the entirety of the midsole so as to illuminate an area 360 degrees about the shoe. The lighting unit includes a housing that is protected through its location within the midsole arch, and a single light strip is positioned from the heel along the entirety of the midsole to the toe. The lighting unit is powered by a rechargeable battery and is selectively operated by a switch that is located along the upper body.

### CROSS-REFERENCE TO RELATED APPLICATIONS

This application claims the benefit of U.S. Application Ser. No. 62/093,758 filed on Dec. 18, 2014, the contents of which are incorporated herein by reference.

### TECHNICAL FIELD

The present invention relates generally to footwear, and more particularly to sneakers with lighted elements.

### BACKGROUND

The statements in this section merely provide background information related to the present disclosure and may not constitute prior art.

There are many known footwear items such as children's sneakers, for example, which employ several bright LED lights along the outside facing portion of the shoe. These lights are typically designed to produce an extremely bright lighting effect that is automatically activated when the child walks or runs. To this end, in many instances, the lighting effect is so bright that it becomes a distraction to others nearby, particularly when they are in a low light situation, such as a car driving at night, for example. Moreover, owing to the disruptive nature of these novelty shoes, and the bright light they produce, many schools are beginning to ban students from wearing such shoes.

Although useful as novelty items, the electronic components of these products typically have a much shorter useful lifespan (typically 1-3 months of active use) as compared to the lifespan of the shoe itself. As such, once the battery of these shoes becomes discharged, the shoe no longer functions as intended. Additionally, these shoes do not function to provide continuous illumination which can aid the wearer in dark or low light situations. For example, children waiting at bus stops in the early morning often carry flashlights to illuminate their path, and to alert vehicles as to the child's presence. However, it is not uncommon for a child to forget to bring a flashlight. When this occurs, he or she is not afforded the protection of the same.

Accordingly, it would be beneficial to provide light emitting footwear that can be selectively activated to provide long lasting and useful illumination to a wearer, without the drawbacks of the above noted shoes.

### SUMMARY OF THE INVENTION

The present invention is directed to light emitting footwear. One embodiment of the present invention can include an upper housing for receiving the foot of a user. A sole is positioned beneath the upper housing and includes a translucent midsole and an outsole having a tread pattern along the bottom end thereof.

A lighting unit is disposed within the midsole and functions to light the entirety of the midsole so as to illuminate an area 360 degrees about the shoe. The lighting unit can include a housing that is protected through its location within the midsole arch, and a single light strip is positioned from the heel along the entirety of the midsole to the toe. The lighting unit can be operated by a switch that is located along the upper body, and can remain illuminated indefinitely. The device can be powered by a rechargeable battery located within the midsole, and can be recharged via a recharging port.

Another embodiment of the present invention can include a reflective coating along the upper portion of the outsole. The coating can function to reflect the light produced by the lighting unit along an entirety of the midsole, and can increase the amount of light that leaves the translucent midsole.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of light emitting footwear that is useful for understanding the inventive concepts disclosed herein.

FIG. 2A is a perspective view of the sole of the light emitting footwear, in accordance with one embodiment of the invention.

FIG. 2B is a top view of the sole of the light emitting footwear, in accordance with one embodiment of the invention.

FIG. 3 is a cutout view of the lighting unit of the light emitting footwear, in accordance with one embodiment of the invention.

FIG. 4 is a simplistic block diagram of the controller of the light emitting footwear, in accordance with one embodiment of the invention.

FIG. 5 is a side view of the light emitting footwear, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

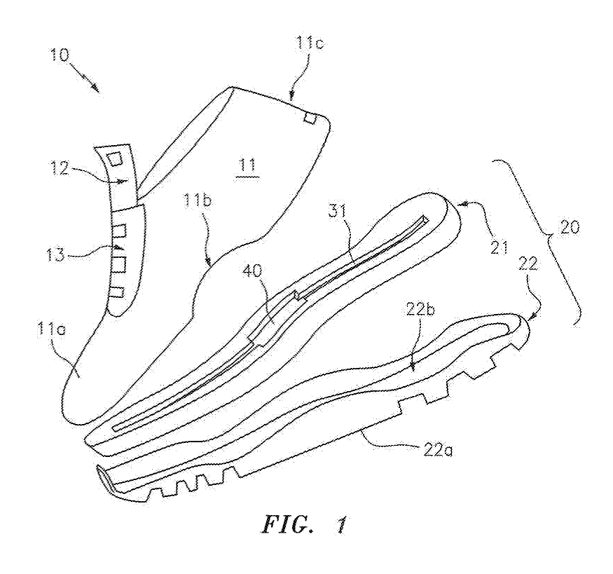

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIG. 1 is an exploded parts view of light emitting footwear 10 that is useful for understanding the inventive concepts described herein. In one embodiment, the footwear can include, essentially, an upper shoe housing 11, a shoe sole 20, and a lighting unit 30.

As shown, the upper housing 11 includes a toe box 11a, instep 11b and heel 11c forming the expected shape and size that is suitable for covering the foot of a human user. The housing can also include a tongue 12 and a fastening unit 13 such as laces, for example, which function in a traditional manner to align and secure the upper housing onto the user's foot.

As will be apparent to those of skill in the art, the main body 11 can also include any number and type of decorative elements such as various colors, markings, words, shapes, symbols, logos, designs, types of materials, texturing of materials, patterns, and/or images, for example. These elements can be secured onto and/or into the main body in accordance with known techniques so as to be flush with the surface of the main body or can be recessed, raised and/or protruding outward from the main body so as to give a three dimensional effect.

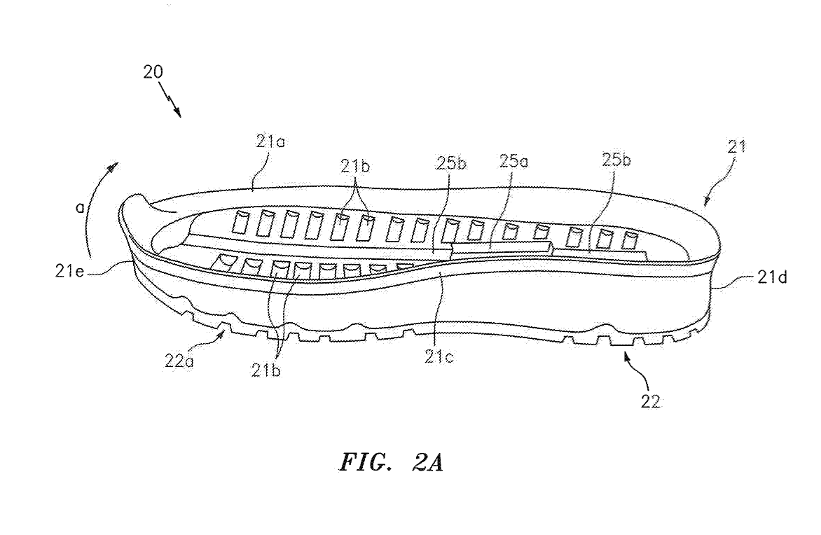

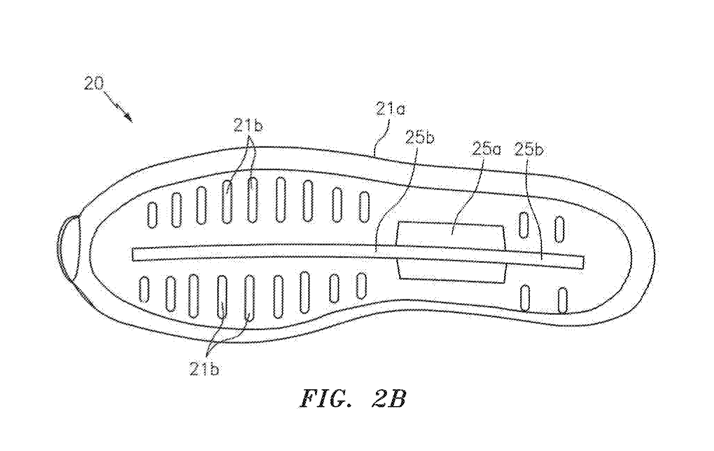

The sole 20 functions to provide the required traction, internal support and external hardiness needed for active footwear, such as sneakers, for example. As shown in FIGS. 2A and 2B, the sole 20 can include a generally translucent midsole section 21 that is secured along the upper surface of the outsole 22.

The outsole 22 can be translucent or non-translucent, and can be constructed from any number of different materials such as rubber or plastic compounds, for example, having a tread pattern 22a along the bottom facing surface thereof. In one embodiment, the outsole 22 can also include a reflective layer/coating 22b along the entirety of the upper facing surface thereof. This coating can be constructed from any number of lightweight malleable materials such as silver fabric or aluminum foil, for example, or reflective adhesive. In this regard, the reflective surface can work in conjunction with the below described lighting unit 40 to produce a continuous 360 degree field of lighting that emanates from the midsole.

The midsole 21 can be constructed exclusively from any number of transparent and/or translucent materials such as various plastics or composites, for example. The midsole 21 can include an elongated upstanding lip 21a that is positioned along the upper periphery for aligning and receiving the main body 11. The midsole can also include a plurality of laterally dispersed ridges 21b that are also translucent in nature. These ridges can most preferably be positioned in a generally perpendicular orientation to the direction a user would walk in the shoe, and function to allow the sole to bend vertically (see arrow a) with each step, thereby increasing the comfort level of the shoe to the user, without blocking the light produced by the lighting unit.

The translucent midsole can also receive the below described lighting unit 30 so as to become fully illuminated when the same is activated. As shown, the midsole can include a controller housing depression 25a having a shape and size that is complementary to the housing body 40a, and an elongated channel 25b having a shape and size that is complementary to the light strip 31. Each of the depression and channel are positioned along the top surface of the midsole.

In the preferred embodiment, the depression 25a can molded into the arch area 21c of the midsole, and the elongated channel 25b can be disposed along the center of the midsole, and extend the entire length of the midsole from the heel end 21d to the toe end 21e thereof. Placement of the depression and channel in these locations are important for two reasons. First, by placing the light strip within the channel as illustrated, it becomes possible for a single light strip to fully illuminate the midsole in a 360 degree radius about the shoe. Moreover, this placement ensures the light strip 31 will only move vertically (see arrow a), as opposed to laterally, thereby preventing the same from becoming damaged over time.

Second, placement of the control unit 40 within the arch portion 21c of the midsole advantageously eliminates much of the downward pressure that is applied onto the shoe from the user's foot. In this regard, the majority of the weight from a user is distributed to the shoe via the heel and toe areas. Therefore, placement of the controller in this area reduces wear and tear on the delicate components, and prolongs the life of the device. This is possible because the lighting unit does not rely on a pressure switch.

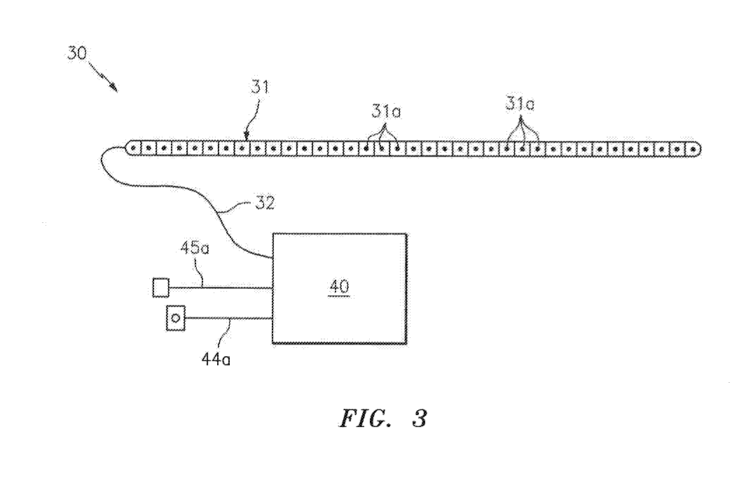

FIG. 3 illustrates one embodiment of the lighting unit 30 that includes a light strip 31 that is operated by a control unit 40 having an external control switch 44a and recharging port 45a.

The light strip 31 can include a plurality of light producing devices 31a such as LEDs for example that are capable of generating any number of different colors at the same or varying intensities, and can also perform any type of lighting effect such as remaining illuminated, flashing, fading, cycling colors, and/or performing a unique or synchronized chasing pattern, for example.

The light strip 31 is preferably positioned within the channel 25b with the lighted elements 31a facing down, toward the outsole. In this regard, when the light strip 31 is activated, the light it produces radiates outward through the translucent midsole 21. Moreover, the light is also reflected by the coating 22b, thereby increasing the veracity of the light, and directing the same 360 degrees from the midsole. Although described above as including a single light strip, this is but one possible implementation, as other embodiments are contemplated wherein a plurality of light strips and/or multiple individual lighted elements can be disposed along or within the midsole and are not tied directly to a light strip. Moreover, the lighting elements are not limited to the use of LEDs, as any type of device capable of generating light can also be utilized.

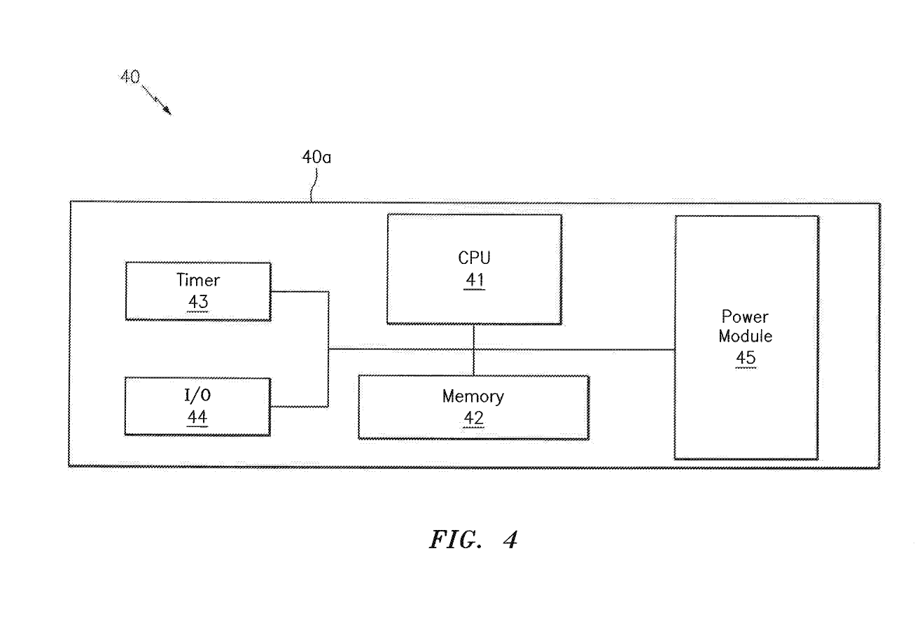

FIG. 4 is a simplified block diagram of the controller 40 of the lighting unit 30. As shown, the control unit can include an enclosure 40a that houses a processor 41 that is conventionally connected to an internal memory 42, a timer module 43, an I/O unit 44, and a power module 45.

The enclosure 40a can house each of the elements in a conventional manner, so as to create a single device. In this regard, the enclosure 40a can take any number of different shapes and sizes, and can be constructed from any number of different materials and methods. In one preferred embodiment, the enclosure 40a can be constructed from lightweight injection molded plastic having a plurality of internal connectors (not shown) for securely housing each of the device elements. The housing 40a can preferably be positioned within the depression 25a of the midsole. The light strip 31 can be physically connected to the control unit 40 via a cable 32.

Although illustrated as separate elements, those of skill in the art will recognize that one or more system components may be, or include one or more printed circuit boards (PCB) containing an integrated circuit or circuits for completing the activities described herein. The CPU may be one or more integrated circuits having firmware for causing the circuitry to complete the activities described herein. Of course, any number of other components capable of performing the below described functionality can be provided in place of, or in conjunction with the below described controller elements.

The processor/CPU 41 can act to execute program code stored in the memory 42 in order to allow the device to perform the functionality described herein. Likewise, a timer module 43 can be provided and can function to accurately measure the passage of time. As described herein, the timer module can be provided as a function of the processor or can include a separate physical circuit. In either instance, processors and timers are extremely well known in the art, therefore no further description will be provided.

Memory 42 can act to store operating instructions in the form of program code for the processor 41 to execute. As described herein, memory can include one or more physical memory devices such as, for example, local memory and/or one or more bulk storage devices.

To this end, the processor, timer and memory can function to generate and send instructions to the light strip 31. These instructions can include the ability to selectively illuminate one or all individual lighting elements of the light strip, so as to perform any type of illumination activity. Additionally, the timer can function to notify the processor to automatically turn off the light strip after a predetermined period of time, such as 10 minutes, for example. Such a feature can prolong the useful life of the battery, and assists a user who forgets to deactivate the light manually.

The input/output unit (I/O) 44 can act to receive a signal from an outside device, and more particularly the push button switch 44a illustrated in FIG. 3. The switch and unit 44 functioning to allow a user to instruct the processor to selectively engage the light strip as described above. The switch can also function to transition the light strip between an on and off position.

The power module 45 can function to provide the necessary power requirements to each element of the controller 40 and to the light strip 31. In one embodiment, the power module can include one or more lightweight rechargeable lithium-ion batteries, for example, which can be positioned within the controller body 40a. Additionally, the power module can include or interface with a charging port such as the micro USB port 45a, for example. Such a feature can allow the batteries within the power module to be recharged.

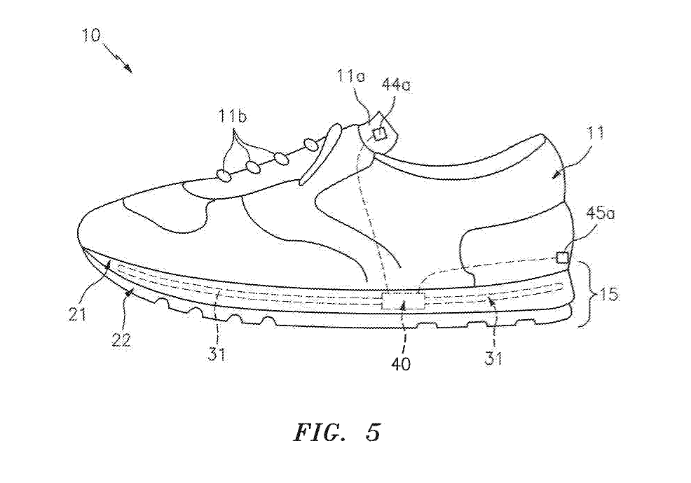

FIG. 5 illustrates one embodiment of the assembled light emitting footwear 10. Although illustrated with the control switch 44a in the tongue 12, and the recharging port 45a along the heel section of the main body 11, this is for illustrative purposes only, as each of these devices can be located anywhere along or within the shoe itself.

In operation, a user can activate the light strip 31 via the switch 44a. Upon being activated, the light strip generates light that passes through the translucent sole 21, and additional light is reflected by the upper layer of the outsole 22b, thereby increasing the overall output of light produced by the device. As the light is not activated by a pressure switch, the light strip remains active regardless of whether the user is standing, walking or sitting, thereby providing a sustained light source.

Moreover, owing to the central placement of the light strip, and the control housing 40a, the balance of the shoe is not affected by the light unit, and the same is protected against damage that would otherwise result from lateral movement and/or downward pressure, as described above. Finally, when the power source becomes depleted, the same can be recharged utilizing a commercially available micro USB cable and/or other suitable type of charging device.

As described herein, one or more elements of the light emitting footwear 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as midsole and outsole, for example, may be formed together as one continuous element, either through manufacturing processes, such as welding, casting, or molding, or through the use of a singular piece of material milled or machined with the aforementioned components forming identifiable sections thereof. Additionally, although illustrated with respect to a sneaker and/or an upper body that covers a human foot, other embodiments are contemplated wherein the upper shoe housing includes an open concept sandal and/or flip-flop design.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A light emitting shoe, comprising:
an upper housing having a shape and size that is suitable for engaging a foot of a human user;
an outsole having a top surface and a bottom surface with a tread pattern disposed thereon;
a midsole that is interposed between the upper housing and the outsole, said midsole being constructed exclusively from a translucent material;
a lighting unit that is positioned within the midsole, said lighting unit being to illuminate an entirety of the midsole when activated;
a control switch that is positioned along the upper housing, said control switch being configured to selectively activate and deactivate the lighting unit; and
a recharging port that is positioned along the upper housing and is in communication with the lighting unit.

2. The shoe of claim 1, wherein the lighting unit comprises:
an elongated light strip having a plurality of light producing devices positioned thereon; and
a controller that includes:
a processor that is in communication with the elongated light strip and the control switch,
a memory that is in communication with the processor,
a power source that includes a rechargeable battery that is configured to supply power to each of the one or more light strips, said power source being in communication with the recharging port, and
a controller housing that encloses each of the processor, memory and power source.

3. The shoe of claim 2, wherein the midsole further comprises:
a housing depression having a shape and size that is complementary to a shape and size of the controller housing; and
an elongated channel that is positioned along a center of the midsole, and extends from a toe end to a front end thereof, said elongated channel including a shape and size that is complementary to a shape and size of the light strip.

4. The shoe of claim 3, wherein the controller housing depression is positioned within an arch portion of the midsole.

5. The shoe of claim 4, wherein the controller housing is positioned within the housing depression along the arch portion of the midsole; and
the light strip is positioned within the elongated channel with the plurality of lighted elements facing down.

6. The shoe of claim 5, wherein the midsole further comprises:
a plurality of laterally dispersed ridges that are disposed along either side of the elongated channel, each of the laterally dispersed ridges being constructed from a translucent material.

7. The shoe of claim 2, wherein each of the plurality of light producing devices consist of:
a Light Emitting Diode that is configured to generate light in a plurality of different colors.

8. The shoe of claim 1, wherein the recharging port comprises a micro USB connector.
